(19) United States
(12) Patent Application Publication
(10) Pub. No.: US 2025/0175332 A1
(43) Pub. Date: May 29, 2025

(54) Physical Cryptocurrency Object

(71) Applicant: Tianzhi Chen, Jersey City, NJ (US)

(72) Inventor: Tianzhi Chen, Jersey City, NJ (US)

(21) Appl. No.: 18/523,622

(22) Filed: Nov. 29, 2023

(51) Int. Cl. H04L 9/10; H04L 9/08

(52) U.S. Cl. CPC H04L 9/10; H04L 9/0825; H04L 2209/56

(57) ABSTRACT

A physical cryptocurrency object is comprised of an enclosed glass sphere with cryptocurrency public and private keys therein to thereby represent currency as a physical, tangible object. The public and private keys are associated with a given user or account on a remote service, such as a cryptocurrency service. The public key within the glass sphere is completely exposed for user reading. The private key within the glass sphere is partially or completely private from physical observation; it may be folded or positioned within another physical object, such as an envelope, box, etc. A user can observe the public key within the glass sphere, type its number into a website connected to a remote cryptocurrency website, and thereby identify the glass sphere's value. However, as in the glass sphere, the private key is completely private and only known by the current owner or cryptocurrency service's manufacturer.

### BACKGROUND

Physical, tangible objects are rarely given a specific value that is universally recognized, if ever. Other than using recognized currency to pay another person for goods or services, it may be difficult for a user to give a user a physical object that represents a given value in terms of currency, such as United States Dollars, Chinese Yuan, Euro, etc.

### SUMMARY

A physical cryptocurrency object is comprised of an enclosed glass sphere with cryptocurrency public and private keys therein to thereby represent currency as a physical, tangible object. The public and private keys are associated with a given user or account on a remote service, such as a cryptocurrency service. The public key within the hollow glass sphere is completely exposed for user reading. The private key within the glass sphere is partially or completely private from physical observation; it may be folded or positioned within another physical object, such as an envelope, box, etc. A user can observe the public key within the glass sphere, type its alpha-numeric characters into a website connected to the cryptocurrency ledger service, and thereby identify the glass sphere's value. However, the private key, as in the glass sphere, is completely private and is only known by one or both of the current owner of the glass sphere or the manufacturer. This way, a third party can personally identify the value of the glass sphere's cryptocurrency value before, for example, purchasing or receiving it as a form of value from its owner.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of a glass sphere with a public key and private key stored therein;

FIG. 2 shows an illustrative representation of the private key written on paper hidden within an envelope;

FIG. 3 shows an illustrative environment in which the public key is connected to a corresponding public key on the cryptocurrency ledger service, which can verify an accurate private key is used to execute a transaction, and a picture of the glass sphere and the public key inside are published on the manufacturer's website.

FIG. 4 shows an illustrative representation of a user searching for and verifying the authenticity of the public key using a computing device;

FIG. 5 is a simplified block diagram of an illustrative architecture of a computing device, such as a user computing device, that may be used at least in part to implement the present physical cryptocurrency disclosure; and

FIG. 6 is a simplified block diagram of an illustrative remote computing device, such as a remote cryptocurrency service or computer system, that may be used in part to implement the present physical cryptocurrency disclosure.

Like reference numerals indicate like elements in the drawings. Elements are not drawn to scale unless otherwise indicated.

### DETAILED DESCRIPTION

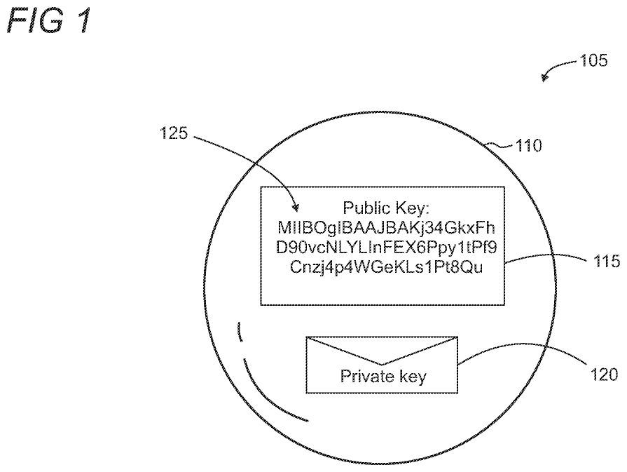

FIG. 1 shows an illustrative representation in which a cryptocurrency object 105 includes a public key 125 and envelope 120 holding a hidden private key enclosed within a hollow glass sphere 110. For example, the public key may be written on physical and tangible a piece of paper 115. The private key may likewise be written on a physical and tangible piece of paper that is stored and sealed within the envelope so that no one can physically observe its alphanumeric characters.

While a glass sphere 110 is shown and described herein, any fully or partially hollow physical object that can house written public and private keys is also possible, such objects comprised of metal, plastic, etc. Furthermore, other shapes of the physical object aside from a sphere are also possible, such as cubes or any polygonal three-dimensional shape, alternatively objects that take a recognizable form, such as a miniature home, real or fictional character's appearance, etc. Put differently, the description of a spherical glass sphere 110 as the cryptocurrency object 105 is exemplary only, and any object or composition that can accomplish the purposes described herein is also possible.

Furthermore, while pieces of paper and an envelope are described herein as the methods to display the public and private keys and store and hide the private key, other physical and tangible objects that can hold a public or private key and house and hide the private key are also possible. For example, the keys may be written on bulkier physical objects like glass, metal, plastic, or other objects that take some physically identifiable form (e.g., home, motorcycle, etc.). The envelope that holds and hides the private key may alternatively be an object big enough or otherwise capable of holding the private key, such as a box or identifiable object that represents some real or fictional world object, like a home, favorite sports team, etc. Put differently, similar to the glass sphere used, any physical objects may be used for the public and private keys and the envelope capable of achieving the purposes described herein.

In one exemplary implementation, the glass sphere 110 may be fully developed with a single small hole or opening to enable a manufacturer or user to input the public and private keys. The opening or small hole may then be sealed with a corresponding glass lid that attaches to the glass sphere 110 with glass glue that is unbreakable. This way, the physical cryptocurrency object 105 is completely sealed and cannot be tampered. Any sort of tampering with the object is observable by a user that the owner may not be trustworthy. In this regard, the glass sphere 110 or other object used is constructed such that it cannot be easily broken and any tampering is readily visible to notify users that the cryptocurrency object may not be viable.

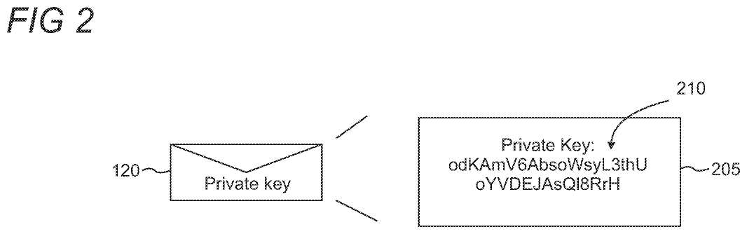

FIG. 2 shows an illustrative representation in which the envelope 120 holds a piece of paper 205 that holds the private key 210. While the private key is shown in FIG. 2 for exemplary and descriptive purposes, a user would find this physical alpha-numeric character value completely unobservable while stored within the glass sphere 110.

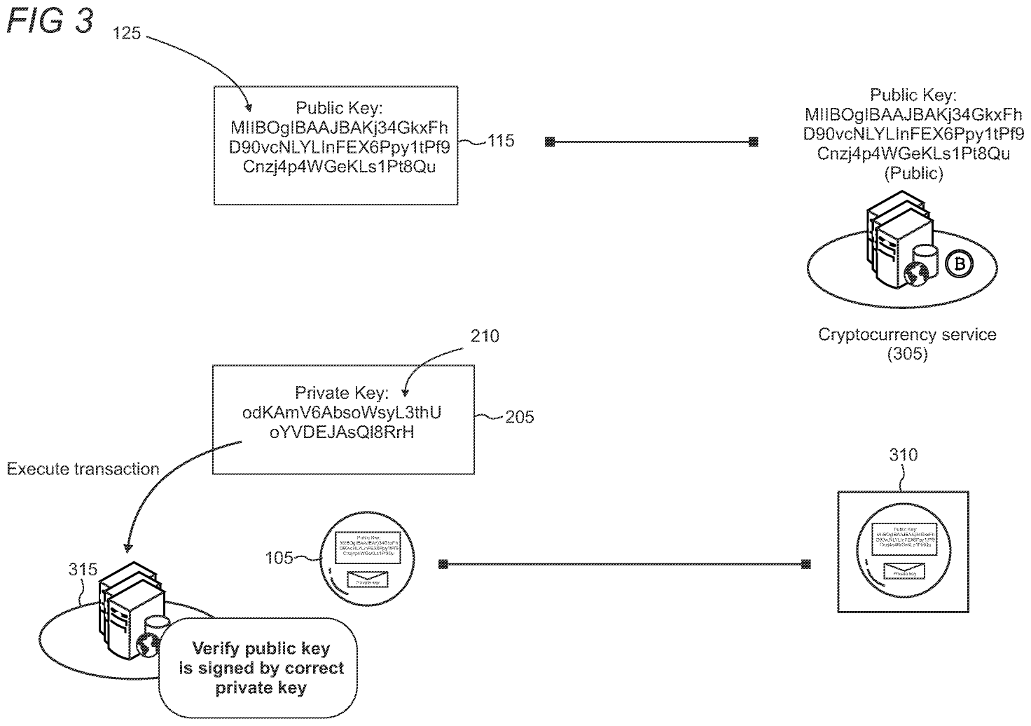

FIG. 3 shows an illustrative representation in which the public key 125 value is directly linked and corresponds with a public key on the authoritative cryptocurrency ledger service 315. The public key 125 on the ledger service is also public to all parties that wish to see it via, for example, a user computing device, but the private key is completely private and sealed in the glass sphere. When a user attempts to execute a transaction, such as transferring cryptocurrency from their account to another, they do so by executing a transaction using their private key and typing in another user's public key (address) to identify to which account to transfer the funds. The ledger service 315 verifies that the transaction is signed by the corresponding private key with the known public key 125 for authenticity, then executes the transaction (transfer of funds) from one account to another. The transaction details, essentially, include the public keys associated with the two account holders so each can be identified, the transaction amount, possibly a fee for the ledger service executing the transaction, and a private key that the transaction executor uses to enable the ledger service to attest to the transaction.

The cryptocurrency service 305 also stores images 310 of the physical cryptocurrency objects 105 so that users, upon checking a public key 125 with the cryptocurrency service, can verify the design of the real-life object matches the one stored in the service's database. This even further provides the user with proof that the person they are dealing with is trustworthy. In this regard, the designs of the glass sphere 110 may be unique to each physical cryptocurrency object 105 to provide another layer of identification reliability and security features to the cryptocurrency objects. The more layers applied to the physical cryptocurrency objects, the more verification can be performed.

The glass sphere's unique design is notable due to the manufacturing process. The process starts by dipping a tube into molten glass. A bit of this hot glass adheres to the tube's end. When air is blown through the tube, the glass expands into a spherical shape like the glass sphere 110. Colored glass particles are introduced to create random patterns. These particles are applied to the molten glass, which sticks to and becomes an integral part of the glass sphere. Next, a user twists the molten glass with pliers just before inflating it with air, which, combined with the air pressure, creates a unique color pattern on the glass sphere. This process of dipping in colored particles and then twisting the molten glass results in the colors moving randomly across the sphere's surface, thereby making it virtually impossible to replicate the exact pattern, ensuring each glass sphere is one-of-a-kind.

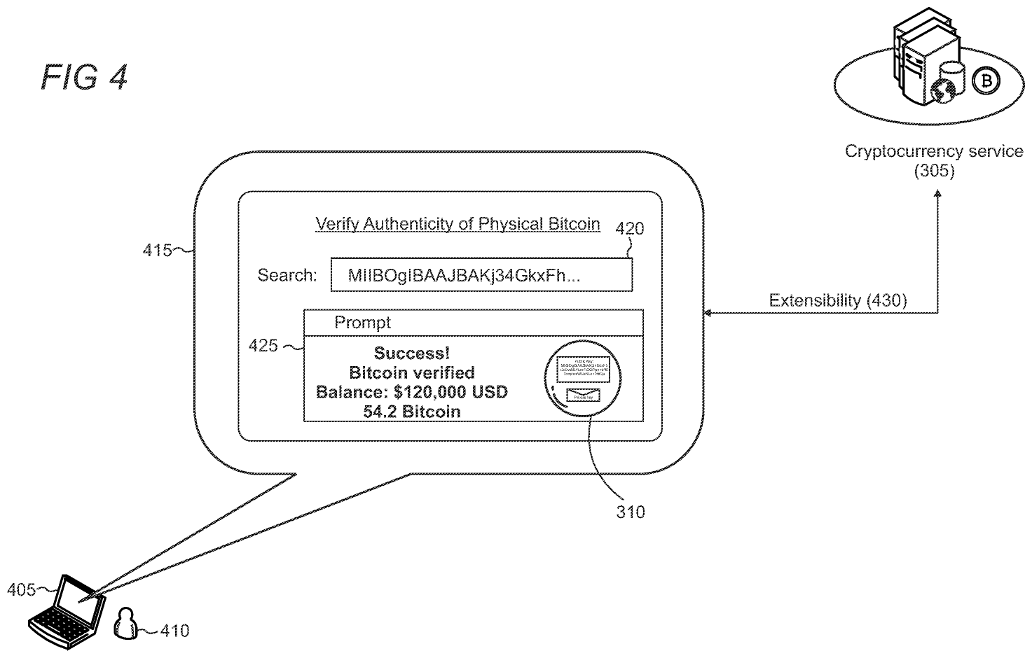

FIG. 4 shows an illustrative representation in which a user 410 operating user computing device 405 can access a URL (uniform resource locator) associated with a website that connects the user to the cryptocurrency service 305. Observing the public key 125 within the cryptocurrency object 105, the user types in the public key's alphanumeric value into a search box 420 on the display 415 at the cryptocurrency service's hosted website. Upon entering the number, the user may hit a search button (not shown), which transmits the typed-in value to the cryptocurrency service for checking its database. The user's computing device 405, accessing the website, has bidirectional extensibility 430 to the cryptocurrency service 305 over one or more networks, including a local area network (LAN), wide area network (WAN), the Internet, the World Wide Web, etc. If the cryptocurrency database identifies a corresponding public key stored within its database, the cryptocurrency service transmits back a success prompt 425, including a monetary value for that cryptocurrency object 105 and an image 310 of the physical cryptocurrency object's aesthetic appearance so the user can verify the tangible object they saw matches the records at the cryptocurrency service, thereby providing another layer of protection.

In this case, the value is $120,000 USD and 54.2 Bitcoin, which may enable the third-party user 410 to determine a suitable exchange with the owner of the cryptocurrency object 105. Thus, the third-party user 410 can personally identify the cryptocurrency object's actual assigned value in cryptocurrency with a reliable third-party cryptocurrency service 305. In terms of monetary value, other forms of value may be output in addition to or alternative that shown, such as Yuan, Euro, Canadian dollar, etc. In this regard, the amounts may be converted via the cryptocurrency service before transmitting the value to the user's computing device 405, which is how Bitcoin and USD are simultaneously shown in FIG. 4.

If the cryptocurrency service 305 cannot identify the typed-in public key in search box 420, then the service may transmit back a prompt that says “failure” or the like, thereby indicating to the user 410 that the cryptocurrency object 105 may be fake, or that the public key was typed in wrong. In any case, the user 410 may not proceed with a deal with the cryptocurrency object's owner until he personally identifies the value with the cryptocurrency service.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

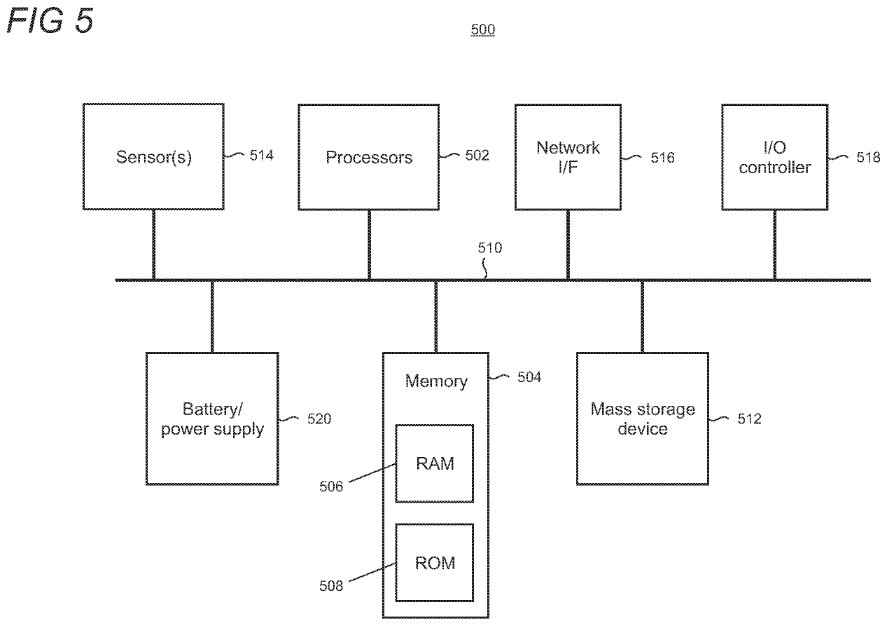

FIG. 5 shows an illustrative diagram of a computer system, such as a smartphone, tablet computer, laptop computer, or desktop computer, that may be utilized to perform the operations herein. The architecture 500 illustrated in FIG. 5 includes one or more processors 502 (e.g., central processing unit, dedicated Artificial Intelligence chip, graphics processing unit, etc.), a system memory 504, including RAM (random access memory) 506 and ROM (read-only memory) 508, and a system bus 510 that operatively and functionally couples the components in the architecture 500. A basic input/output system containing the basic routines that help to transfer information between elements within the architecture 500, such as during startup, is typically stored in the ROM 508. The architecture 500 further includes a mass storage device 512 for storing software code or other computer-executed code that is utilized to implement applications, the file system, and the operating system. The mass storage device 512 is connected to the processor 502 through a mass storage controller (not shown) connected to the bus 510. The mass storage device 512 and its associated computer-readable storage media provide non-volatile storage for the architecture 500. Although the description of computer-readable storage media contained herein refers to a mass storage device, such as a hard disk or CD-ROM drive, it may be appreciated by those skilled in the art that computer-readable storage media can be any available storage media that can be accessed by the architecture 500.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVD, HD-DVD (High Definition DVD), Blu-ray, or other optical storage, a magnetic cassette, magnetic tape, magnetic disk storage or other magnetic storage device, or any other medium which can be used to store the desired information and which can be accessed by the architecture 500.

According to various embodiments, the architecture 500 may operate in a networked environment using logical connections to remote computers through a network. The architecture 500 may connect to the network through a network interface unit 516 connected to the bus 510. It may be appreciated that the network interface unit 516 also may be utilized to connect to other types of networks and remote computer systems. The architecture 500 also may include an input/output controller 518 for receiving and processing input from a number of other devices, including a keyboard, mouse, touchpad, touchscreen, control devices such as buttons and switches, or electronic stylus (not shown in FIG. 5). Similarly, the input/output controller 518 may provide output to a display screen, user interface, a printer, or other output device types (also not shown in FIG. 5).

It may be appreciated that the software components described herein may, when loaded into the processor 502 and executed, transform the processor 502 and the overall architecture 500 from a general-purpose computing system into a special-purpose computing system customized to facilitate the functionality presented herein. The processor 502 may be constructed from any number of transistors or other discrete circuit elements, which may individually or collectively assume any number of states. More specifically, the processor 502 may operate as a finite-state machine in response to executable instructions contained within the software modules disclosed herein. These computer-executable instructions may transform the processor 502 by specifying how the processor 502 transitions between states, thereby transforming the transistors or other discrete hardware elements constituting the processor 502.

Encoding the software modules presented herein also may transform the physical structure of the computer-readable storage media presented herein. The specific transformation of physical structure may depend on various factors in different implementations of this description. Examples of such factors may include but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

The architecture 500 may further include one or more sensors 514 or a battery or power supply 520. The sensors may be coupled to the architecture to pick up data about an environment or a component, including temperature, pressure, etc. Exemplary sensors can include a thermometer, accelerometer, smoke or gas sensor, pressure sensor (barometric or physical), light sensor, ultrasonic sensor, gyroscope, among others. The power supply may be adapted with an AC power cord or a battery, such as a rechargeable battery for portability.

In light of the above, it may be appreciated that many types of physical transformations take place in the architecture 500 in order to store and execute the software components presented herein. It also may be appreciated that the architecture 500 may include other types of computing devices, including wearable devices, handheld computers, embedded computer systems, smartphones, PDAs, and other types of computing devices known to those skilled in the art. It is also contemplated that the architecture 500 may not include all of the components shown in FIG. 5, may include other components that are not explicitly shown in FIG. 5, or may utilize an architecture completely different from that shown in FIG. 5.

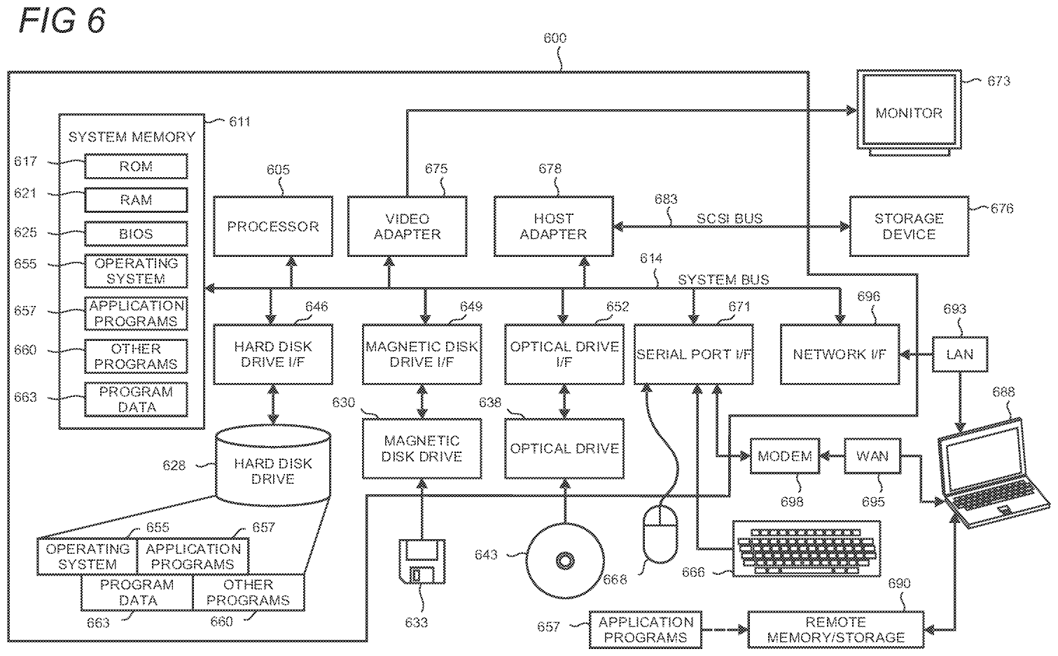

FIG. 6 is a simplified block diagram of an illustrative computer system 600 such as a server (such as NFT-Blockchain servers or social media platform servers), personal computer, or laptop computer with which the present physical cryptocurrency application may be implemented.

Computer system 600 includes a processor 605, a system memory 611, and a system bus 614 that couples various system components including the system memory 611 to the processor 605. The system bus 614 may be any of several types of bus structures, including a memory bus or memory controller, a peripheral bus, or a local bus using any of a variety of bus architectures. The system memory 611 includes read-only memory (ROM) 617 and random-access memory (RAM) 621. A basic input/output system (BIOS) 625, containing the basic routines that help to transfer information between elements within the computer system 600, such as during startup, is stored in ROM 617. The computer system 600 may further include a hard disk drive 628 for reading from and writing to an internally disposed hard disk (not shown), a magnetic disk drive 630 for reading from, or writing to a removable magnetic disk 633 (e.g., a floppy disk), and an optical disk drive 638 for reading from or writing to a removable optical disk 643 such as a CD (compact disc), DVD (digital versatile disc), or other optical media. The hard disk drive 628, magnetic disk drive 630, and optical disk drive 638 are connected to the system bus 614 by a hard disk drive interface 646, a magnetic disk drive interface 649, and an optical drive interface 652, respectively. The drives and their associated computer-readable storage media provide non-volatile storage of computer-readable instructions, data structures, program modules, and other data for the computer system 600. Although this illustrative example includes a hard disk, a removable magnetic disk 633, and a removable optical disk 643, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present physical cryptocurrency application. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof are intended to cover non-transitory embodiments and do not include waves, signals, and/or other transitory and/or intangible communication media.

A number of program modules may be stored on the hard disk, magnetic disk 633, optical disk 643, ROM 617, or RAM 621, including an operating system 655, one or more application programs 657, other program modules 660, and program data 663. A user may enter commands and information into the computer system 600 through input devices such as a keyboard 666 and pointing device 668 such as a mouse. Other input devices (not shown) may include a microphone, joystick, gamepad, satellite dish, scanner, trackball, touchpad, touchscreen, touch-sensitive device, voice-command module or device, user motion or user gesture capture device, or the like. These and other input devices are often connected to the processor 605 through a serial port interface 671 that is coupled to the system bus 614 but may be connected by other interfaces, such as a parallel port, game port, or universal serial bus (USB). A monitor 673 or other type of display device is also connected to the system bus 614 via an interface, such as a video adapter 675. In addition to the monitor 673, personal computers typically include other peripheral output devices (not shown), such as speakers and printers. The illustrative example shown in FIG. 6 also includes a host adapter 678, a Small Computer System Interface (SCSI) bus 683, and an external storage device 676 connected to the SCSI bus 683.

The computer system 600 is operable in a networked environment using logical connections to one or more remote computers, such as a remote computer 688. The remote computer 688 may be selected as another personal computer, a server, a router, a network PC, a peer device, or other common network node, and typically includes many or all of the elements described above relative to the computer system 600, although only a single representative remote memory/storage device 690 is shown in FIG. 6. The logical connections depicted in FIG. 6 include a local area network (LAN) 693 and a wide area network (WAN) 695. Such networking environments are often deployed, for example, in offices, enterprise-wide computer networks, intranets, and the Internet.

When used in a LAN networking environment, the computer system 600 is connected to the local area network 693 through a network interface or adapter 696. When used in a WAN networking environment, the computer system 600 typically includes a broadband modem 698, network gateway, or other means for establishing communications over the wide area network 695, such as the Internet. The broadband modem 698, which may be internal or external, is connected to the system bus 614 via a serial port interface 671. In a networked environment, program modules related to the computer system 600, or portions thereof, may be stored in the remote memory storage device 690. It is noted that the network connections shown in FIG. 6 are illustrative, and other means of establishing a communications link between the computers may be used depending on the specific requirements of an application of the present physical cryptocurrency application.

What is claimed:

1. A physical cryptocurrency object, comprising:
a tangible public object on which a public key is written, in which the public key on the tangible public object is exposed for viewing;
a tangible private object on which a private key is written, in which the private key on the tangible object is hidden for viewing; and
a glass object having at least a partially hollow interior, wherein the tangible public object and the tangible private object are positioned and sealed within the glass object.

2. The physical cryptocurrency object of claim 1, wherein the tangible public object is paper.

3. The physical cryptocurrency object of claim 2, wherein the tangible private object is paper.

4. The physical cryptocurrency object of claim 3, wherein the glass object is a sphere.

5. The physical cryptocurrency object of claim 4, wherein the public key and the private key are alphanumeric characters.

6. The physical cryptocurrency object of claim 5, wherein the tangible private object is encapsulated by another object inside the glass object to prevent its private key from being viewed.

7. The physical cryptocurrency object of claim 6, wherein the glass object's exterior has a unique pattern.

8. The physical cryptocurrency object of claim 7, wherein the public key and the private key on their respective tangible public object and tangible private object are linked to a database associated with a cryptocurrency service to enable users to verify the authenticity of the physical cryptocurrency object.

9. The physical cryptocurrency object of claim 8, wherein the cryptocurrency service hosts a website publicly accessible by user computing devices, wherein the cryptocurrency service receives a user-input public key at a user computing device and checks its database for a corresponding public key and its associated monetary value, and wherein the cryptocurrency service transmits at least the monetary value to the user computing device.
